(19) United States
(12) Patent Application Publication
(10) Pub. No.: US 2011/0173890 A1
(43) Pub. Date: Jul. 21, 2011

(54) Garage Door Sensor Protector

(76) Inventor: Mark A. Gantner, St. Peters, MO (US)

(21) Appl. No.: 12/690,679

(22) Filed: Jan. 20, 2010

(51) Int. Cl. E05F 15/20

(52) U.S. Cl. 49/25

(57) ABSTRACT

A housing for protecting a garage door safety beam emitter or receiver from impact and from the elements. The housing has a transverse plane of symmetry such that the same style housing may be used over the emitter and over the receiver, the housings being minor images of each other when installed. The housing includes a flange by which the housing may be attached to a garage door track or to the framework around the garage door. The housing preferably is formed of plastic such that it can be trimmed to accommodate installation, for example, around a foundation and includes a side wall with an aperture through which LED diagnostic lights associated with the emitter or receiver may be viewed.

Priority is claimed from U.S. application Ser. No. 29/332,552, filed Feb. 19, 2009, for Cover For A Garage Door Transmitter/Receiver.

### BACKGROUND OF THE INVENTION

1. Field of the Invention

The present invention relates to a housing for protecting a garage door safety beam emitter or receiver.

2. Brief Description of the Prior Art

In order to prevent the closing of a garage door upon an obstruction, it is known in the art to pass a sensor beam between an emitter and a receiver across the garage door opening. Usually, the sensor beam is oriented in a direction generally parallel to the garage floor and the emitter and receiver are carefully aligned. Passage of the beam across the garage door opening is monitored, and when the beam is broken, an electric garage door controller either stops the electric motor moving the door or reverses the direction of the motor to move the door upward.

When a garage door operating system is installed, the emitter and receiver are mounted a short distance above the garage floor, on the inside of the garage, outside of the garage door track where they are vulnerable to damage from vehicles, lawn mowers, bicycles and other moving objects. The emitter and receiver are also susceptible to corrosion from moisture, dirt and road salt.

Little attention has been paid in the industry to the vulnerability of the emitter and receiver in a garage door operating system. If either the emitter or the receiver is knocked out of alignment, the garage door operating system stops working. In many instances, this triggers a service call because the home owner does not know how or have the tools to realign the sensors. A properly designed garage door sensor protector would prevent this from happening. A service call is expensive, either to the home owner, or to the installer if the door is still under warranty. Having a garage door sensor protector would provide the home owner with peace of mind and extra protection against future inconvenience or expense. In addition, the protector may extend the life of the sensors by protecting them from the elements.

### BRIEF SUMMARY OF THE INVENTION

In view of the above, it is an object of the present invention to provide a housing for protecting a garage door safety beam emitter or receiver from impact and exposure to the elements. It is another object to provide a housing which is easy to install on a garage door track or on a framework surrounding the doorframe. It is also an object to provide a housing which minimizes service calls and provides the original installer or service provider an opportunity to increase ticket sales by adding a pair of housings. Other objects and features of the invention will be in part apparent and in part pointed out hereinafter.

In accordance with the invention, a garage door sensor housing is substantially symmetrical about a transverse plane for use on either a safety beam emitter or a safety beam receiver. The housing includes a front and back wall joined together with a top and bottom wall. The front wall has an opening for exposing an active component of a safety beam emitter or a safety beam receiver. A side wall joins the front, back and top and bottom walls. The side wall has an opening for use in observing LEDS which may be provided on the emitter or receiver. A notch is provided in the top and bottom walls adapted to fit around a garage door track. A mounting flange is provided along an open side of the housing opposite the side wall and continuing along the notch for mounting the housing to the garage door track or to a framework supporting the door track.

In an embodiment of the invention, the opening in the side wall includes a grating of parallel bars. In another embodiment a corner of the housing is chamfered along an interface between the side wall with the back wall to deflect impacts and stiffen the housing. In other embodiments a channel is provided in the flange for electric wires connecting the emitter or receiver with the door control system. In some embodiments a first elongated slot is provided in the flange for mounting the housing to the door track and a second elongated slot is provided in the flange for mounting the housing to the framework around the garage door track, the slots facilitating alignment.

The invention summarized above comprises the constructions hereinafter described, the scope of the invention being indicated by the subjoined claims.

### BRIEF DESCRIPTION OF THE SEVERAL VIEWS OF THE DRAWING

In the accompanying drawings, in which one of various possible embodiments of the invention is illustrated, corresponding reference characters refer to corresponding parts throughout the several views of the drawings in which:

FIG. 1 is a perspective view of a garage door sensor housing in accordance with the present invention;

FIG. 2 is a rear perspective view of the housing mounted on a garage door track and on a framework surrounding the door frame;

FIG. 3 is front perspective view of the housing;

FIG. 4 is a top plan view of the housing, the bottom being identical;

FIG. 5 is a right side elevational view of the housing, said right side having a grating;

FIG. 6 is a back elevational view of the housing;

FIG. 7 is a front elevational view of the housing; and,

FIG. 8 is a left side elevational view of the housing, said left side being open.

### DETAILED DESCRIPTION OF THE INVENTION

Referring to the drawings more particularly by reference character, reference numeral 10 refers to a garage door sensor housing in accordance with the present invention. Housing 10 is designed for use with either a safety beam emitter 12 or a safety beam receiver 12 placed on opposite sides of a garage door opening. The emitter/receiver pair 12 form a two-element arrangement for determining the presence of an object or person in the doorway. In some garage door systems, receiver 12 may be a mirror with a detector located in emitter 12.

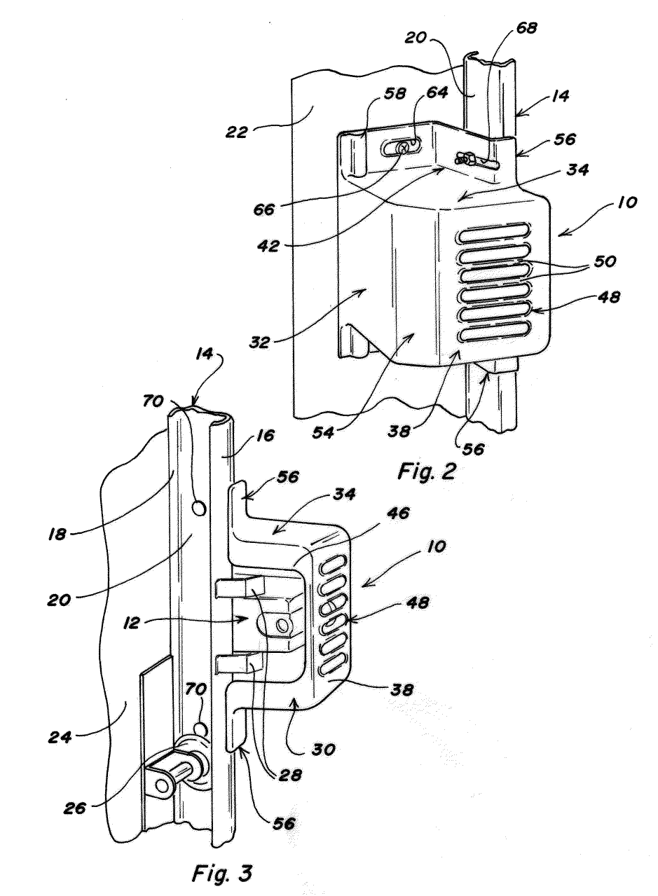

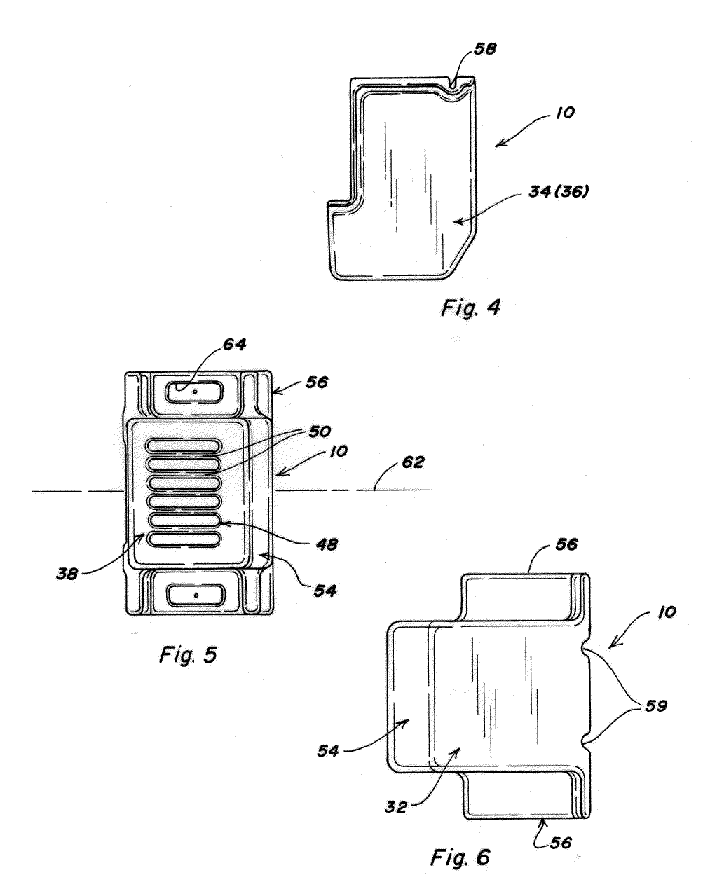

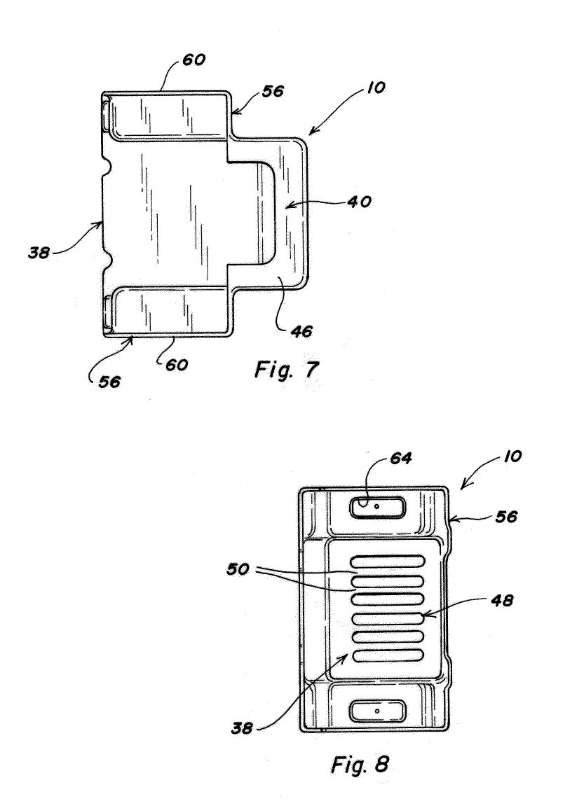

As shown in FIG. 3, a garage door track 14 has a hollow interior with a slot. Hollow interior is formed between a concave gutter or channel portion 16 and a base 18. Track 14 is mounted along its bottom 20 to a framework 22 (FIG. 2) or mounting brackets (not shown) near the doorframe. With continuing reference to FIG. 3, a door 24 is mounted on rollers 26 which travel along concave gutter or channel portion 16 as the door is raised and lowered. Emitter/receiver pair 12 is mounted outside of concave gutter or channel portion 16 of garage door track 14 a distance above a garage floor. Emitter/receiver 12 may be clamped 28 to garage door track 14 with snap-fit action or otherwise attached to the track or the doorframe.

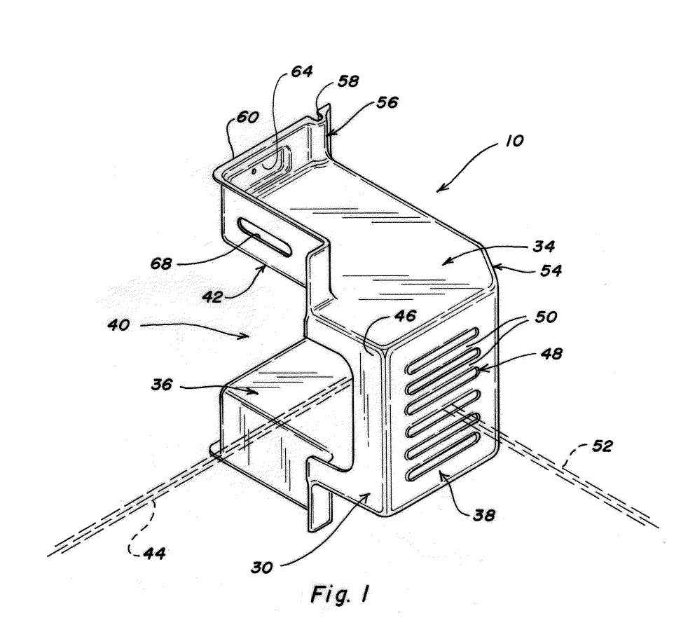

Turning now to FIG. 1, housing 10 is a box, a front wall 30 of which is substantially open for passage of a light beam as more particularly discussed below. A closed back wall 32 is best seen in FIGS. 2 and 6. Front and back walls 30, 32 are joined together with a top wall 34 and a bottom wall 36. A side wall 38 attached to front 30, back 32, top 34 and bottom wall 36 completes the box which is generally rectangular with a substantially open side 40. While shown as rectangular, it will be understood that the walls may meet other than at right angles without affecting the functionality of housing 10 as more particularly described below.

A notch 42 is provided in top wall 34 and bottom wall 36 adapted to conform to garage door track 14 along its bottom 20 and concave gutter or channel portion 16. While front wall 30 is substantially open for exposing a light beam 44 (FIG. 1) transmitted or received by emitter or receiver 12, a web partially frames 46 the opening along side wall 38 and top and bottom walls 34, 36 extending to notch 42.

Side wall 38 includes an aperture 48 through which a workman can view the emitter/receiver 12. This is required as some emitters/receivers 12 such as those sold by Genie have status lights which may be used by a workman to troubleshoot operation of the garage door operating system. In newer garage door operating systems, onboard diagnostics are provided and LEDs may flash in a particular sequence to indicate misalignment or other functional problems. Aperture 48 may include a grating of parallel bars 50 which permits viewing of LED status lights 52 (FIG. 1) without unduly weakening side wall 38.

As best seen in FIG. 1, a corner 54 of housing 10 is chamfered along the interface of side wall 38 with back wall 32 for two important reasons: Chamfered corner 54 helps in deflecting an accidental impact to housing 10 and it also stiffens housing 10 by triangulation of the walls.

A flange 56, illustrated as a right angle flange, is provided on top and bottom walls 34, 36 along open side 40 and notch 42. Flange 56 along open side 40 may include channels 58 for the usual electrical wires connecting emitter/receiver 12 to the rest of the door control system. Notches 59 (FIG. 6) may be provided in back wall 32 for the same purpose. The free edges of flange 56 may be finished with a rolled edge 60 for stiffening (FIG. 1).

Housing 10 is preferably formed from a plastic material that is tough enough that it may be deformed without tearing and preferably has memory which allows it to spring back to its original shape as soon as the deforming force is released. Housing 10 is preferably made of a durable plastic that is also flexible enough to be cut with snips when necessary to fit the housing around an obstacle such as a foundation. An illustrative but not limiting suitable plastic for this purpose is a copolymer polypropylene. Housing 10 may be vacuum formed, molded or otherwise made as a unitary piece or constructed in pieces which are joined with adhesive or the like. While less preferred, housing 10 could be formed of metal or wood.

Housing 10 may be mounted top and bottom over emitter/receiver 12 by flange 56 to garage door track 14 or to wood framework 22. As shown in FIG. 2, flange 56 along open side 40 includes an elongated slot 64 through which a screw 66 or other fastener may be used to attach housing 10 to framework 22. Alternatively, or additionally, housing 10 may be mounted to garage door track 14 by flange 56 along notch 42. In this instance also, an elongated slot 68 may be provided for fasteners 70. Elongated slots 64, 68 facilitate mounting alignment of housing 10 in different situations. While fasteners such as screws are preferred, flange 56 may be attached to framework 22 or garage door track 14 with an adhesive such as double-sided adhesive tape.

As shown in the drawings, housing 10 is substantially symmetrical about a transverse plane 62 (FIG. 5) which permits installation of identical housings over emitter 12 and receiver 12, one housing 10 being the mirror image of the other. In use, housings 10 protect emitter 12 and receiver 12 from being damaged or impacted, the most common causes being impacts from bikes, scooters and trash cans. In addition to protecting emitter 12 and receiver 12 from impacts, housings 10 also protects them from corrosion due to moisture, dirt, road salt and so forth.

In view of the above, it will be seen that the several objects of the invention are achieved and other advantageous results attained. As various changes could be made in the above constructions without departing from the scope of the invention, it is intended that all matter contained in the above description or shown in the accompanying drawings shall be interpreted as illustrative and not in a limiting sense.

What is claimed:

1. A garage door sensor housing substantially symmetrical about a transverse plane for use on either a safety beam emitter or a safety beam receiver with the emitter or receiver mounted on a garage door track or to a doorway frame supporting the door track, said housing comprising:
a front and back wall joined together with a top and bottom wall, said front wall having an opening for passage of a light beam between the emitter and the receiver, a side wall joined to the front, back and top and bottom walls,
a notch in the top and bottom walls adapted to receive a garage door track,
a flange along the top and bottom walls, said flange extending along an open side opposite the side wall and along the notch,
whereby said housing may be attached by the flange along the notch to the bottom of the track or by the flange along the open side to the doorway frame.

2. The housing of claim 1 wherein the side wall has an opening through which diagnostic LEDS associated with the emitter or receiver may be viewed.

3. The housing of claim 1 wherein a corner is chamfered along an interface of the side wall with the back wall.

4. A garage door sensor housing substantially symmetrical about a transverse plane for use on either a safety beam emitter or a safety beam receiver with the emitter or receiver mounted on a garage door track or to a doorway frame supporting the door track, said housing formed as one piece from a tough but resilient plastic material and comprising:
a front and back wall joined together with a top and bottom wall, said front wall having an opening for passage of a light beam between the emitter and the receiver, a side wall joined to the front, back and top and bottom walls, said side wall having an opening with a grate through which diagnostic LEDS associated with emitter or receiver may be viewed,
a notch in the top and bottom walls adapted to receive a garage door track,
a flange along the top and bottom walls, said flange extending along an open side opposite the side wall and along the notch,
whereby said housing may be attached by the flange along the notch to the bottom of the track or by the flange along the open side to the doorway frame.

5. The housing of claim 4 wherein a corner is chamfered along an interface of the side wall with the back wall.

6. The housing of claim 5 wherein a first elongated slot is provided in the flange along the open side and a second elongated slot is provided in the flange along the notch.

7. The housing of claim 6 wherein the flange has a channel for electric wires leading to the emitter or the receiver.

8. The housing of claim 6 wherein the back wall has notches for electric wires leading to the emitter or the receiver.

9. The housing of claim 4 wherein the opening in the side wall has a grate.

10. The housing of claim 9 wherein the grate is formed from parallel bars.
